(19) United States
(12) Patent Application Publication
(10) Pub. No.: US 2007/0130032 A1
(43) Pub. Date: Jun. 7, 2007

(54) Dimension validation rules

(75) Inventors: Kimberly Ann Nelson, Fargo, ND (US); Ronald H. Schulz, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/296,812

(22) Filed: Dec. 7, 2005

(51) Int. Cl. G07F 19/00

(52) U.S. Cl. 705/30

(57) ABSTRACT

A computer-implemented accounting system supports generation of a dimension validation rule that incorporates a wildcard. The wildcard provides means for limiting application of the dimension validation rule.

### BACKGROUND

Modern business solutions software provides businesses with a vast array of powerful tools. Such solutions are known to provide integrated capabilities for financial management, distribution, manufacturing, project accounting, human resource management, field service management, and business analytics. Within such solutions, one aspect often provides automated business accounting functions.

Whether provided as a module in an integrated business solutions application, or as a stand-alone system, corporate accounting is configured to support conformance with some level of standardized accounting practices. Such software supports the use of balance sheets that provide a snapshot of a business' financial condition at a specific moment in time, usually at the close of an accounting period. Most accounting software also includes revenue, expense, and/or capital withdrawal accounts in the form of temporary accounts that are reset at the end of an accounting period so that they will have zero balances at the start of the next period.

Recently, accounting software has begun to provide user-definable transaction dimensions for improved tracking and business analytics. A user-definable transaction dimension is similar to a variable that contains additional information relative to a transaction. These user-definable transaction dimensions are used to classify, report, and analyze financial transactions based upon a user's specific business needs. The number of transaction dimensions that can be defined by a user are essentially unlimited and include such dimensions as cost center, profit center, region, and hours, as well as predefined system transaction dimensions such as customer, vendor, item, and site. These user-defined transaction dimension codes are attached to ledger transactions which eliminates the need to analyze transactions on the basis of account segments.

The use of financial dimensions to essentially augment or capture relevant business information in a given ledger transaction is highly desirable. Thus, users can now enter a host of additional information relative to a given ledger transaction. However, this feature can also be a limitation if data accuracy is not addressed. For example, a user who erroneously indicates that a ledger transaction is related to a given cost center, when, in fact, the transaction is not so related, runs the risk of generating a chain of errors. First, the erroneously indicated cost center will show the transaction, while the proper cost center will not. Thus, it becomes vitally important that data accuracy is achieved and maintained. To date, enforcement of data entry for ledger transactions has been done by restricting data entry based on the ledger account with which a user is interacting. This approach suffers from a number of drawbacks, which will become apparent after reading the specification below.

The discussion above is merely provided for general background information and is not intended to be used as an aid in determining the scope of the claimed subject matter.

### SUMMARY

A computer-implemented accounting system supports generation of a dimension validation rule that incorporates a wildcard. The wildcard provides means for limiting application of the dimension validation rule.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which some embodiments may be practiced.

FIG. 2 is a schematic block diagram of a simplified financial record system.

FIG. 3 is a table illustrating a number of transactions tracked using a number of dimensions.

FIG. 4 is a diagrammatic view of a graphical user interface illustrating the creation of a dimension set in accordance with one embodiment.

FIG. 5 is a diagrammatic view of a graphical user interface illustrating the generation of a hierarchy relative to the dimension set created in FIG. 4.

FIG. 6 is a diagrammatic view of a graphical user interface illustrating the generation of one or more rules relative to a dimension set in accordance with one embodiment.

FIG. 7 is a diagrammatic view of a dimension set with multiple hierarchies related thereto in accordance with an embodiment.

FIG. 8 is a diagrammatic view of a graphical user interface illustrating data entry in accordance with one embodiment.

FIG. 9 is a diagrammatic view of operation of a computer-implemented accounting system in accordance with one embodiment.

FIG. 10 is a flow diagram of a method of configuring a computer-implemented accounting system in accordance with an embodiment.

FIG. 11 is a method of facilitating data entry with a computer-implemented accounting system in accordance with an embodiment.

FIG. 12 is a block flow chart demonstrating steps associated with generating and applying a dimension validation rule.

FIG. 13 is a block flow chart demonstrating steps associated with selecting a dimension value.

### DETAILED DESCRIPTION

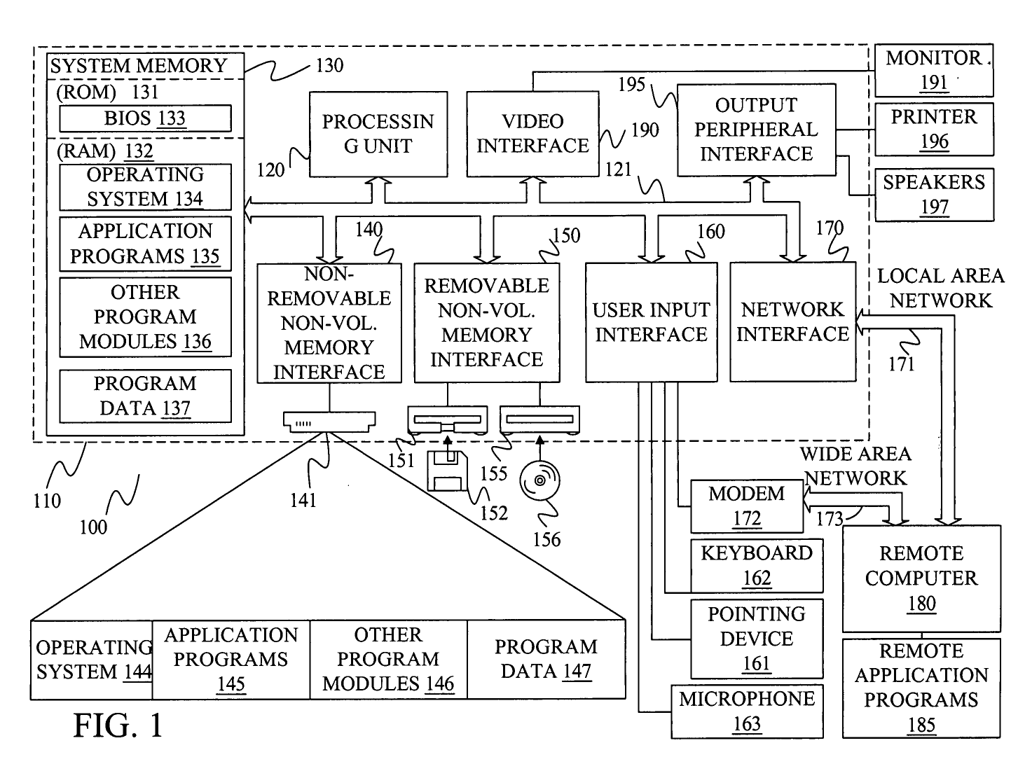

FIG. 1 illustrates an example of a suitable computing system environment 100 on which embodiments may be implemented. The computing system environment 100 is only one example of a suitable computing environment and is not intended to suggest any limitation as to the scope of use or functionality of various embodiments. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by one or more computers. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Application programs 145 can include automated accounting software and/or an entire enterprise resource planning (ERP) system. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

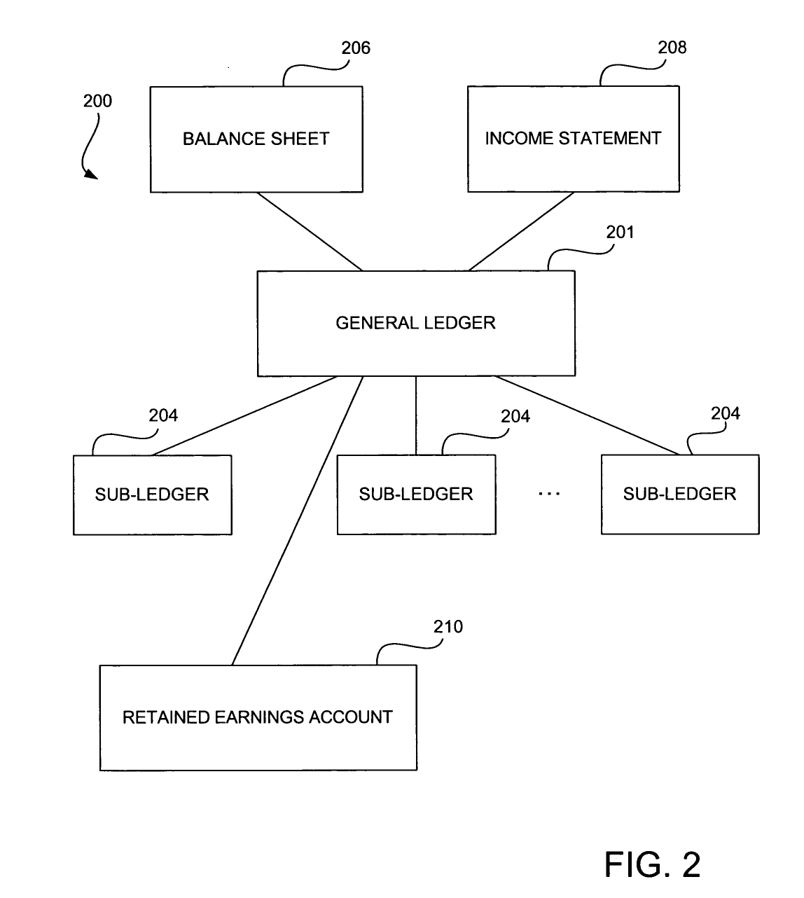

FIG. 2 is a schematic block diagram of a simplified financial record system 200 that represents one context within which embodiments can be implemented. System 200 can be a stand-alone financial record keeping (accounting) system, or it can be a financial module of a larger system, such as an enterprise resource planning (ERP) system. The core of system 200 is general ledger 201, which generally consists of a series of transactions stored on one or more suitable storage devices such as one or more hard disks. All financial transactions flow through general ledger 201 so as to support the creation of a permanent financial history.

System 200 also includes a plurality of sub-ledgers 204 that track specific items such as cash, accounts receivable, accounts payable, payroll, inventory and the like. All entries posted to sub-ledgers 204 will transact through general ledger 201. For example, when a customer pays off a bill with cash, the transaction will be posted to the general ledger and the two appropriate sub-ledgers 204 (i.e., cash and accounts receivable).

Balance sheet 206 and income statement (sometime referred to as a “profit and loss” statement) 208 are financial documents that are drawn directly from general ledger 201. More specifically, general ledger 201 will contain the balances that make up line items on reports 206 and 208.

Balance sheet 206 is typically configured to provide an overview of financial condition at a given point in time such as at the close of an accounting period. The overview generally includes at least assets (anything the business owns) and liabilities (claims of creditors against assets of the business). In contrast, income statement 208 provides a profit/loss summary during a predetermined period of time, such as a month, quarter or one-year. The summary will generally include revenues and operating expenses for the business during the relevant time period.

It is common for system 200 to be implemented in the specific context of a software application. It should be noted that, for the purpose of illustrating basic components, system 200 is very simply presented. When actually applied in the context of real-world businesses, the structure of such a system can become quite complex, particularly when applied in the context of a large company having a sophisticated enterprise-oriented organization scheme.

Generally accounting software helps a business to conform to standardized accounting practices. Most applications include reporting functionality in the form of support for balance sheets and/or income statements. In addition, most applications also include revenue, expense, and/or capital withdrawal accounts in the form of temporary accounts that are reset at the end of an accounting period so that they will have zero balances at the start of the next period (commonly one year). Closing entries are the journal entries used to transfer balances of temporary accounts to permanent accounts. After the closing entries have been made, the temporary account balances will be reflected in a more permanent account such as a retained earnings account. A retained earnings account 210 is indicated in FIG. 2.

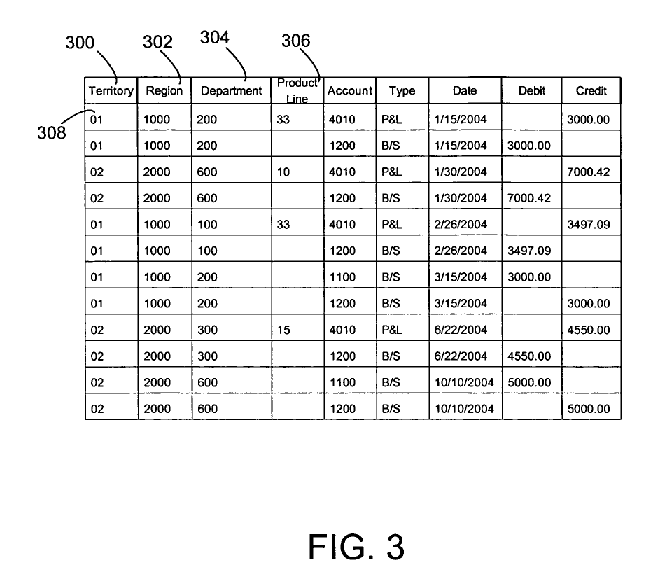

FIG. 3 is a table of journal entries illustrating the use of transaction dimensions. Specifically, the user has selected or otherwise defined four distinct dimensions illustrated in FIG. 3. Territory 300, region 302, department 304, and product line 306 are all user-defined transaction dimensions illustrated in FIG. 3. A given general ledger transaction line 308 is then augmented with information, to the extent known, relative to the dimensions. For example, transaction line 308 is augmented with territory information indicating that the transaction is related to territory 01, region information indicating region 1000, department information indicating department 200, and product information indicating product line 33. Additionally, each transaction line transacts relative to a selected account and the type of that account is listed, whether it is a profit and loss account (P&L) or a balance sheet (B/S) account.

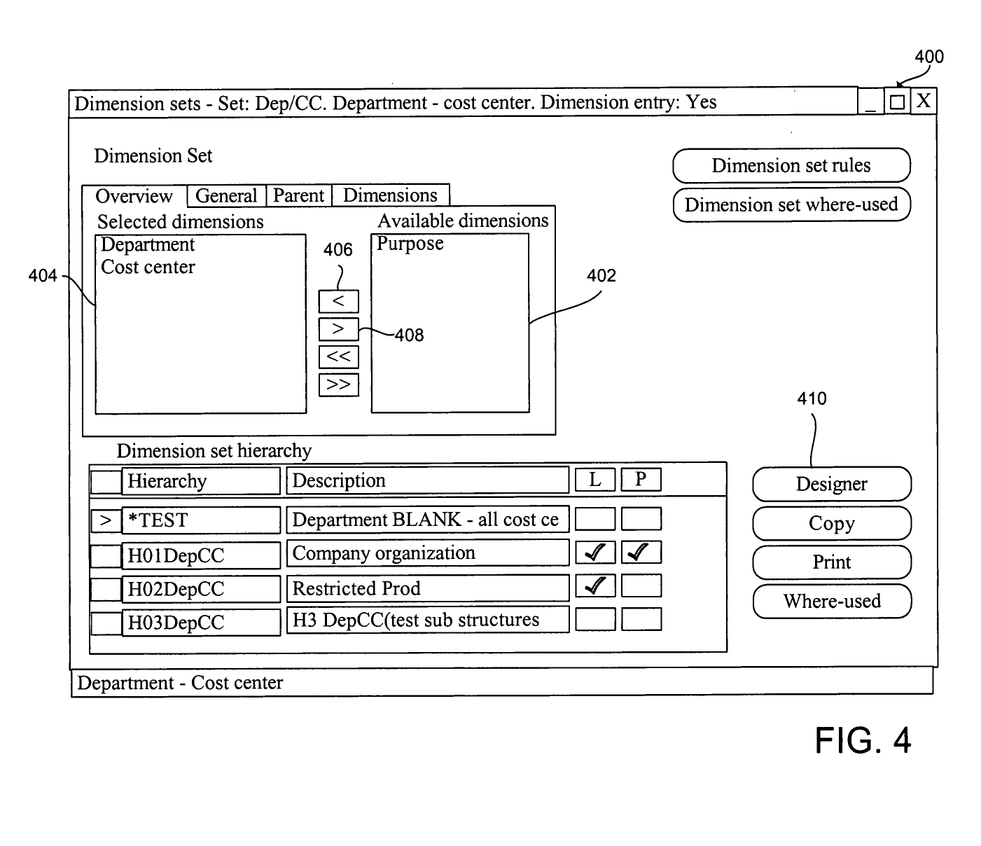

FIG. 4 is a diagrammatic view of graphical user interface (GUI) 400 illustrating creation of a dimension set in accordance with one embodiment. GUI 400 is invoked or otherwise generated when a user issues a command indicative of his or her wish to create a dimension set. The first step in creating a dimension set is selecting among the available dimensions which dimensions will be members of the set. GUI 400 shows box 402 providing a listing of available, but unselected, dimensions. In FIG. 4, box 402 only contains the dimension “Purpose” while selected dimensions box 404 contains the dimensions “Department” and “Cost Center.” GUI 400 also includes add button 406 and remove button 408. When GUI 400 was first invoked, it listed Department, Cost Center and Purpose in box 402 and box 404 was blank. The user then selected each of Department and Cost Center, and pressed add button 406 to move dimensions “Department” and “Cost Center” from available box 402 to selected dimensions box 404. The dimension set has also been given a name: “Dep/CC. Department-cost center” by the user. A dimension set can include any positive integer number of financial transaction dimensions, including one. Once a dimension set is created, one or more dimension value constraints can be created and associated with the dimension set. Preferably, such constraints are in the form of one or more hierarchies. Additionally, a default hierarchy can also be associated with the dimension set thereby enforcing basic restrictions of dimension field values or field value combinations if there is no other hierarchy to apply in a given context. In the example illustrated in FIG. 4, hierarchy generation is done by pressing, or otherwise selecting, designer button 410. Once button 410 is pressed, a new graphical user interface is generated.

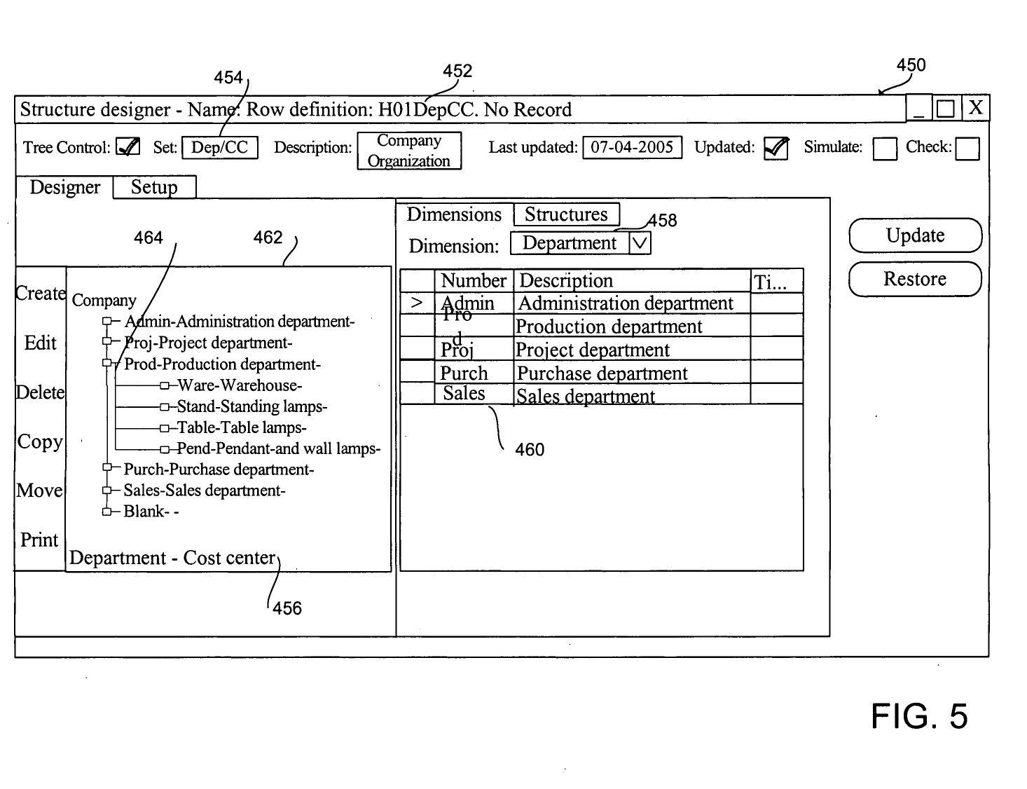

FIG. 5 is a diagrammatic view of a graphical user interface generated when button 410 (illustrated with respect to FIG. 4) is pressed. GUI 450 includes hierarchy title field 452 illustrating that the hierarchy being created or otherwise affected in GUI 450 is titled H01DepCC. Dimension set box 454 illustrates that the hierarchy is related to dimension set Dep/CC, while box 456 provides the longer description of the dimension set, “Department-Cost Center.” GUI 450 illustrates dimension selector field 458 indicating selection of the “Department” field. Box 460 illustrates a number of allowed values in the department dimension. Specifically, the allowed values are Admin, Prod, Proj, Purch, and Sales. These values are illustrated hierarchically in box 462. Moreover, GUI 450 allows valid cost center values to be assigned for each department. Line 464 illustrates that the cost centers: Ware, Stand, Table, and Pend are cost centers within the Prod, or Production, department. Several hierarchies can be built for a given dimension set. Each hierarchy of a dimension set defines different versions or authorized values and/or value combinations relative to that dimension set.

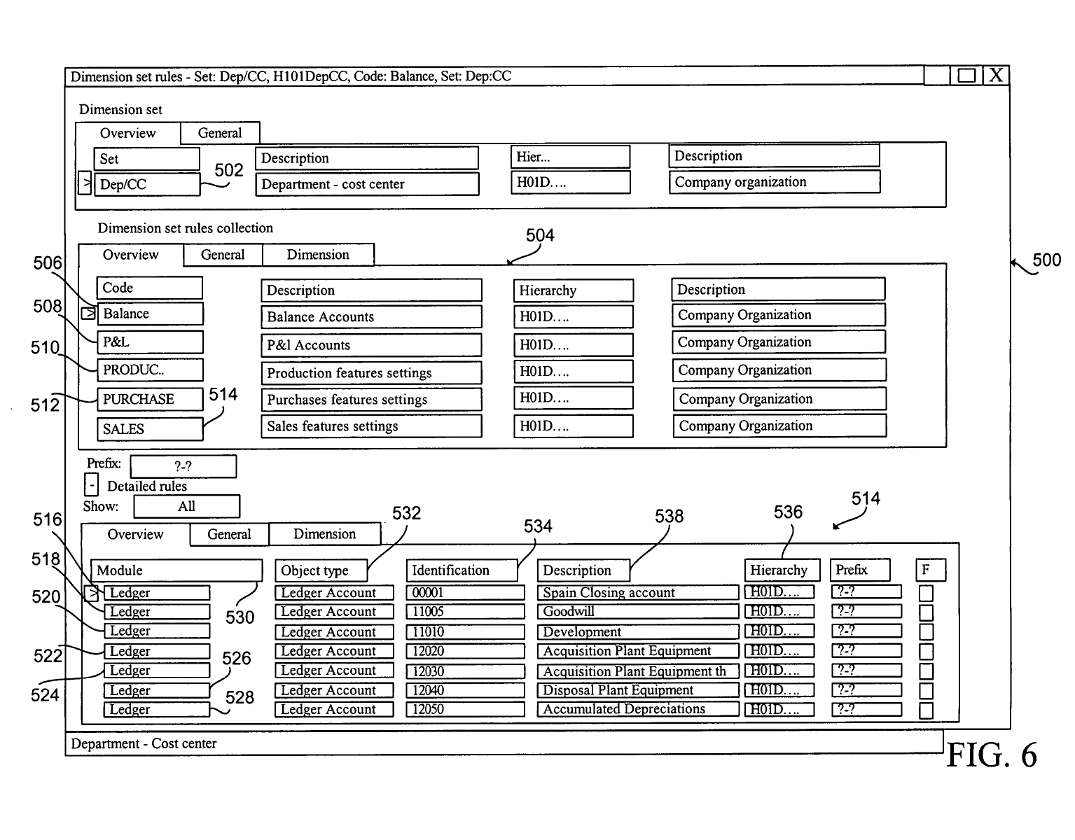

FIG. 6 is a diagrammatic view of a graphical user interface illustrating the generation of one or more rules related to a dimension set in accordance with one embodiment. GUI 500 facilitates the creation and modification of rules relative to hierarchies. A rule identifies, under a given context, the financial dimension sets on which to restrict values or combinations of values. A rule also identifies the sets' hierarchies, which are to be enforced for restricting, or otherwise guiding, the entry of dimension values. Finally, a rule identifies the context in which it applies. Context is a process-oriented combination of data. Types of information that can be used, either alone or in combination, to form context data include the ledger account, journal names (such as a payment journal or an expense journal), table collection, and data entry forms (such as a purchase order entry form).

GUI 500 is configured to help a user generate and/or modify dimension set rules. GUI 500 includes dimension set drop-down 502 which, when activated, displays a list of available dimension sets. In the example illustrated in FIG. 6, the dimension set Dep/CC has been selected. GUI 500 includes dimension set rules collection portion 504 illustrating a number of rule type overviews 506, 508, 510 and 512. As illustrated, a user has selected Balance overview 506. This selection causes detailed rules section 514 to display individual rules 516, 518, 520, 522, 524, 526 and 528. Each rule includes information 530 about the module of the accounting software that to which it is relevant, such as “Ledger.” Further, each rule also includes information 532 indicating what object type the rule impacts, and also includes an identification number 534 of the rule. Further still, each rule includes information 536 indicating the hierarchy to which it applies as well as a general description 538. Each of the rules has its own context criteria, which when matched by a user entering transaction data, will enforce, or otherwise guide, data entry based upon the rule's definition. Rules can be configured to allow only certain dimension values or they can be configured to exclude certain values. Moreover, the rules can be tailored such that combinations of dimension values can be allowed or excluded.

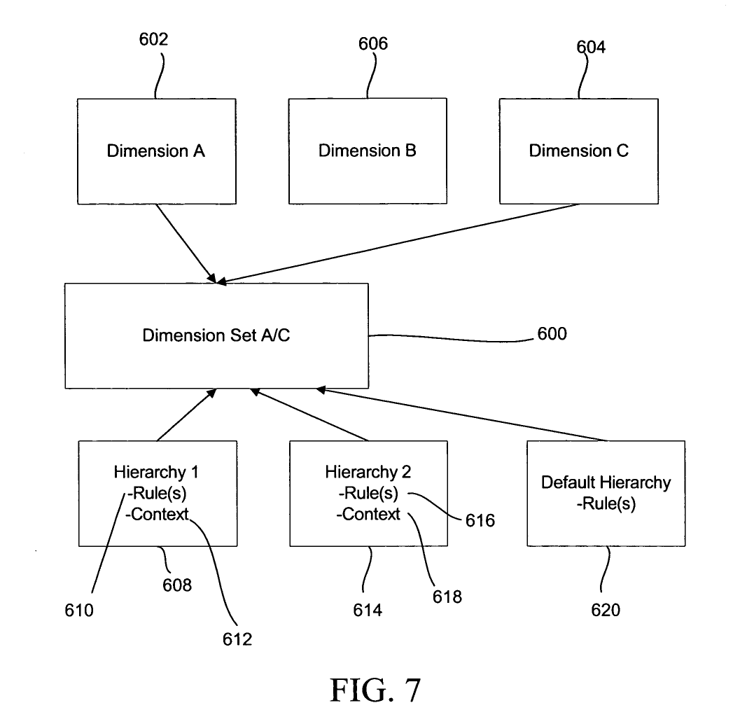

FIG. 7 is a diagrammatic view of a dimension set with multiple hierarchies related thereto in accordance with an embodiment. Dimension set 600 is defined to include dimensions A (602) and C (604), but not dimension B (606). The definition or creation of set 600 can be done in any suitable manner, such as that set forth above with respect to FIG. 4. Dimension set 600 has three distinct hierarchies. Hierarchy 608 includes one or more rules 610 that fire when user-defined context 612 is satisfied, or otherwise supplied during transaction data entry. Hierarchy 614 includes one or more rules 616 that fire when user-defined context 618 is satisfied, or otherwise supplied during transaction data entry. Finally, hierarchy 620 is a default hierarchy that fires if no other hierarchies have context information that is satisfied during data entry. FIG. 7 illustrates multiple hierarchies 608 and 614 existing relative to dimension set 600, such that different data entry validation/enforcement can be achieved in different contexts.

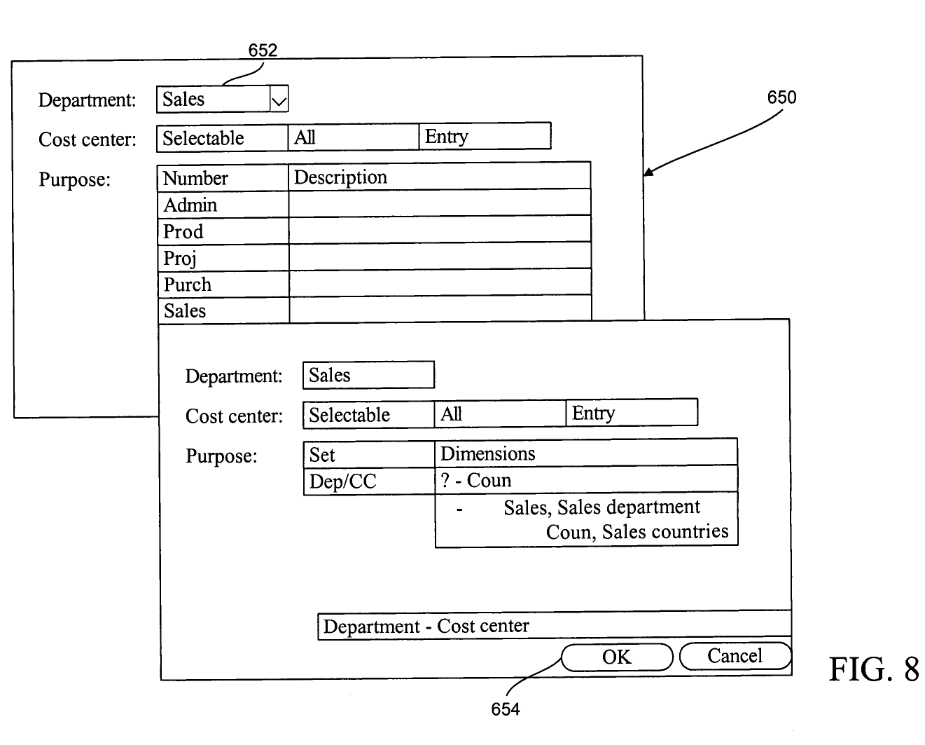

FIG. 8 is a diagrammatic view of a graphical user interface illustrating data entry in accordance with one embodiment. GUI 650 is generated in response to a given user's interaction with the computer-implemented accounting system. Such interaction may include selecting a button or menu item indicative of the user's desired type of data entry. For example, the user may press a button that reads “Enter Purchase Order.” User actions, such as interacting with the system through a graphical user interface, or other suitable interface, generates contextual information. Moreover, the user's identity can also be used for additional contextual information. Thus, a data entry clerk may receive a different data entry interface than a high-level manager. Based on one or more pieces of contextual information, the system, which may be embodied on or within operating environment 100, generates data entry GUI 650. Dimension fields are preferably drop-down fields such as field 652. However, other data entry formats and techniques where a user is presented with a closed group selection can also be used. Once the user has entered the requisite data, the user preferably indicates that he or she is finished entering data. One way in which this is accomplished is by pressing the “OK” button 654. When the user selects “OK,” the system attempts to post the new information to the ledger. However, prior to posting, the system enforces the rules for the user's context to ensure that only valid dimension values, or combinations thereof, are entered and posted. Moreover, the dimension values can also be controlled against any rules expressed on the ledger account to which the user is posting.

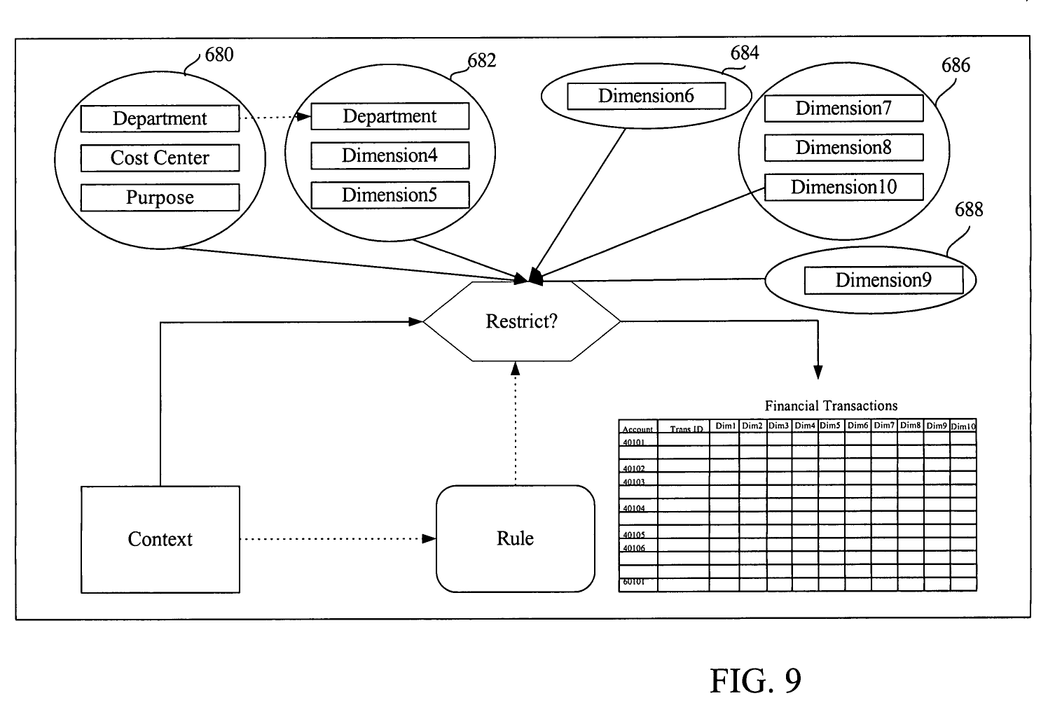

FIG. 9 is a diagrammatic view of operation of a computer-implemented accounting system in accordance with one embodiment. FIG. 9 illustrates five distinct dimension sets 680, 682, 684, 686 and 688. Dimension set 682 shares a dimension “Department” with dimension set 680, and thus dimension set 682 is a subset of dimension set 680. FIG. 9 also illustrates dimension sets 684 and 688 each being comprised of a single dimension. Each of dimension sets 680, 682, 684, 686 and 688 can have one or more hierarchies and contextual rule(s) defined relative to the given dimension set. Thus, data entry relative to each transaction can vary based on the contextual information generated prior to, and/or during data entry.

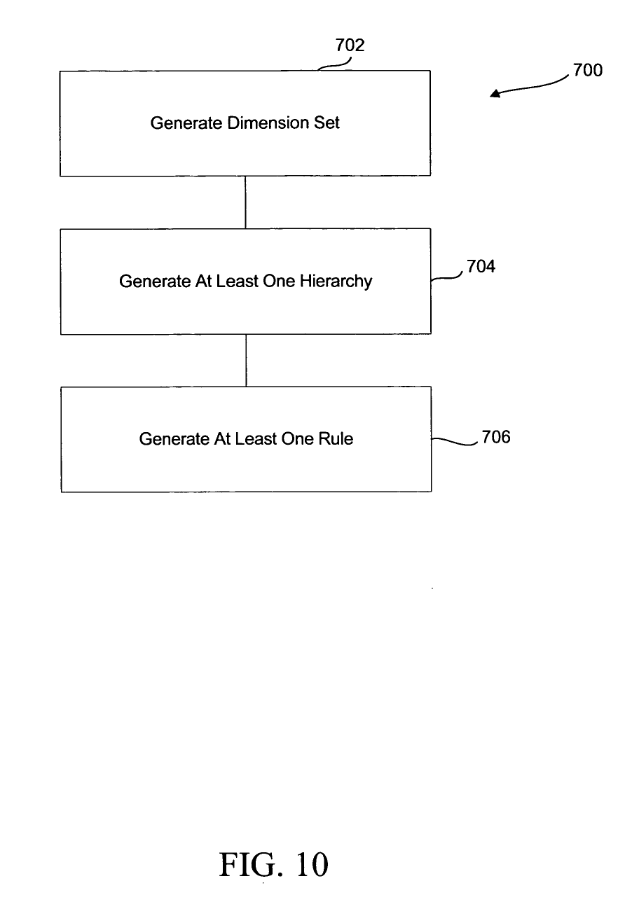

FIG. 10 is a flow diagram of a method of configuring a computer-implemented accounting system in accordance with an embodiment. Method 700 begins at block 702 where a dimension set is generated. The dimension set includes any suitable number of selected dimensions, including one. Once the dimension set is generated at block 702, at least one hierarchy is created at block 704. A hierarchy is an example of a dimension value constraint that is imposed upon data entry. The constraint may require that a given cost center be a member of a selected department. A rule is another form of dimension value constraint, which may require that if the entered department is “Production” then the only available cost centers are “Ware—warehouse, Stand—Standing Lamps, Table—Table lamps, and Pend—Pendant and Wall lamps.” A hierarchy is essentially a data structure or record that stores information regarding relationships between dimensions. A hierarchy may be stored with, or include, one or more rules that specify actual allowed or excluded dimension values or combinations thereof. Thus, a hierarchy may indicate that cost centers are dependant on departments. For each hierarchy, one or more rules can be defined, as indicated at block 706. Each rule has a pattern portion indicating contextual criteria to determine when the rule should fire. For example, one rule may be configured to fire only when a purchase order is being entered relative to the production department. Each rule also has an action portion that specifies what action will occur when the rule fires. For example, the rule may specify that the user be informed that the given data entry is invalid, and prompt the user to select among a number of valid choices. In this manner, detailed information relative to allowed or excluded dimension field values or combinations thereof can be specified in a way that varies depending upon the context in which it is confronted.

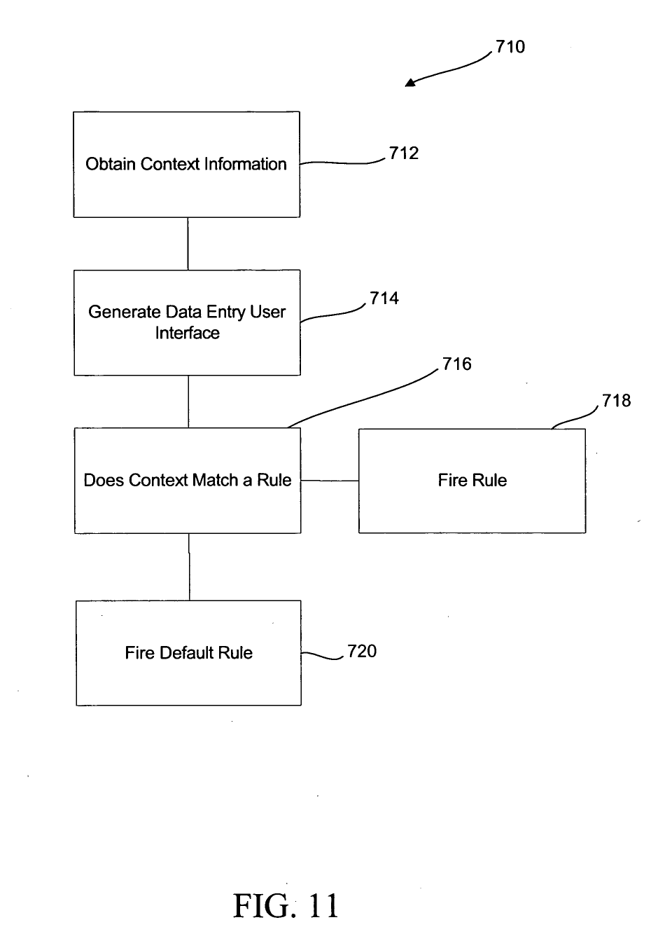

FIG. 11 is a method of facilitating data entry with a computer-implemented accounting system in accordance with an embodiment. Method 710 begins when a user wishes to enter transaction data. The user's interaction with the computer-implemented accounting system generates contextual information, as indicated at block 712. Once the contextual information is obtained, a data entry user interface is provided to the user for entry of the transaction data, as indicated at block 714. At block 716, the accounting system determines whether the context information obtained at block 712 matches the pattern portions of any stored rules, as indicated at block 716. If a specific rule does match the context information, that rule is fired as indicated at block 718. The firing of a rule at block 718 may create an action that informs the user that a specific data entry value or combination thereof is not allowed. The action may further guide the user to select a value for one or more dimensions from a closed list with respect to at least one dimension. If none of the rule portions match, during block 716, a default rule can be fired, as indicated at block 720. A default rule can restrict the authorized values and/or combinations of values on the dimension set to those set in a default hierarchy.

Thus, it is conceivable that a system could be configured to enable documentation of business activity through entry of any dimension combinations and values. Under the circumstances, for several reasons, such as user error, there is much potential for entry of improper dimension data. Dimension validation rules, such as those described herein, provide a means to specify certain dimension combinations and/or values as valid or invalid. The entry of dimension information can then be policed accordingly in order to lessen or eliminate the possibility that invalid dimension data will be entered. In one embodiment, a user is provided with access to a limited listing of valid dimension data from which to choose or select. In another embodiment, dimension validation rules can be implemented on an account-specific basis (e.g., for a given account or accounts, certain dimensions or dimension values are defined as valid or invalid).

Thus, as has been described, it is beneficial to enable a user to define the rules or restrictions upon which the determination of validity or invalidity is based. In one embodiment, a system is configured to default to a setting in which all dimension code combinations and values are considered valid, thus eliminating the necessity for validation rules or restrictions to be established. However, if there is a desire to control which dimensions or dimension values can or cannot be used in certain circumstances (e.g., with certain account numbers, etc.), then validation rules can be defined and applied.

For example, it may be desirable for a user to specify that a Department dimension code “Field Sales” is valid in combination with a Functional Area dimension code “Sales and Marketing.” In another example, the same user may desire to restrict the Department dimension code “Documentation” to never be valid with the Functional Area dimension code “General and Administrative.” Restrictions can be placed not just on the combination of dimensions in a given set but also or alternatively on the values that can be entered for given dimension. The restriction of values may be context specific (e.g., if a particular dimension is included in a set, then the values that are valid for a different dimension in the set may be specifically limited).

Validation rules can be defined so that specific dimension values are required, optional or never allowed. Specific values can also be used when defining whether a particular combination of dimensions is allowed (or a particular combination of dimensions together with a particular account, etc.). Unlimited validation rules can be defined. In one embodiment, the system is configured to enforce entry of acceptable dimension data. In another embodiment, it is possible to specify that one or more additional pieces of information may or must be entered when a particular validation rule is invoked.

In one embodiment, to simplify rule definition, wildcards are supported. Wildcards are used to specify all, a range, or a list of values applicable to a validation rule. Wildcards can be used to specify all, a range or a list of accounts applicable to a validation rule. In this latter case, as compared to defining rules on an account-by-account basis, wildcards allow for the definition of fewer rules that need to be maintained and enforced. For example, it may be desirable to specify that, for an account range from 4000 to 4040 (4000:4040), Project 100 and Department 500 are valid entries. In another example, it may be desirable to configure all Departments that start with the number 5 (5*) are invalid with Division 1. All system-supported wildcards are illustratively available when defining a validation rule.

In one embodiment, valid combinations are configured to provide valid values to a calling subsystem based on information provided. For example, a valid combination rule might state that for account 11*, Division 01:04 (i.e., divisions one through four) and all Departments are valid. The same rule might state that if Division 01 is entered, then the Department must be 500. In this case, the system is illustratively configured to return the values of 01, 02, 03 and 04 for Division when account 1103 is known. If account 1103 and Division 01 are known, the system will only return 500 for the Department.

In accordance with one embodiment, dimension validation rules are made applicable to a relational chart of accounts. For a given relational chart of accounts, a user illustratively has the ability to select dimensions they want to validate against a given account number (alternatively, the account number itself can be implemented as a dimension or, alternatively, wildcarding can be used to specify a range of accounts). In one embodiment, by default, any dimension not selected to be validated with an account number will always be valid. The user illustratively has the option to configure the system such that if a matching validation rule cannot be found, then the combination is invalid.

It is to be understood that, when defining validation rules, wildcarding is not limited to defining applicable accounts. Also, wildcarding is not limited to defining applicability by defining a range from a first value to a second value. A system could just as easily be configured to support other wildcarding operators such as, but not limited to, greater than, less than, equal or not equal to. In fact, wildcarding can include any means of defining applicability based on a characteristic instead of identity. Other examples include an ‘in between’ operator, a ‘contains’ operator or an ‘all’ operator. Wildcarding can also be implemented based on the result of an operation (e.g., a certain validation rule is applicable if the sum of two dimension values is greater than a predetermined value n, or if a calculated sales percentage is greater than a predetermined value n, etc.). These are just a few of many potential examples that, given the present description, are obviously within the scope of the present invention.

It is also to be understood that a wildcard can be configured to operate on data that is inside or outside of a dimension context. In other words, when a data source is examined to determine whether a wildcard limitation is applicable, that data source isn't necessarily, but could be, a dimension value. Reference could potentially be made to any data source.

Once a user has selected dimensions that they want to validate, the user can define unlimited rules (e.g., rules for different general ledger Distribution types, such as Sales, Accounts Payable, Purchasing, etc.). If a rule is not defined for a particular general ledger Distribution type, then all combinations are illustratively valid and optional. The validation rules can be defined using specific values or by using wildcards, for example, to define an applicable range. For each element of a validation rule, the user can illustratively define whether the element is required, optional or not allowed.

The system is then illustratively configured to validate a prescribed account and dimension combination as it is entered, for example entered into the general ledger distribution line, for any transaction. Information from the transaction will illustratively be used to determine which rules(s) to validate against. The system is also illustratively configured to provide valid value lists for a given dimension based on known information from the calling transaction. If one dimension code is valid for a specific dimension, then that dimension code will illustratively default onto the general ledger distribution line.

The manner in which a user is able to define valid combinations is very flexible. In most cases, there is likely to be more than one way to define the same rule.

An example will now be provided. For the purpose of the example, it will be assumed that a company has two dimensions, namely, Store and Product Category. It will also be assumed that a user wants to validate against all dimensions. The data for the example is as follows:

Control Possibilities

| | |
|---|---|
| R = | Required |
| O = | Optional |
| NA = | Not Allowed |

Store

| | |
|---|---|
| A | Pets, Unlimited-Fargo |
| B | Pets, Unlimited-Grand Forks |
| D | Pet Supplies-Fargo |
| E | Pet Supplies-Grand Forks |
| F | Pet Supplies-Detroit Lakes |
| G | Pet Services-Fargo |

Product Categories

| | |
|---|---|
| 001 | Food |
| 002 | Litter |
| 003 | Treats |
| 004 | Boarding |
| 005 | Grooming |
| 006 | Aquarium Cleaning |
| 007 | Beds |
| 008 | Toys |

Account Numbers

| | |
|---|---|
| 4000 | Sales |
| 6* | Expenses |

As part of the example, three different scenarios will be provided. In a first scenario, the user wants to specify that only the Pet Services Store can sell the Product Categories that are services. The Product Categories that are Services include 004—Boarding, 005—Grooming and 006—Aquarium Cleaning. Department codes are not entered against Sales. The user also wants to specify that when the Product Categories that are services are used, the number of Hours must be entered. Note that Hours will be considered additional information. One way to accomplish the noted goals is as follows:

SCENARIO #1 TABLE

| | | | | Product | | | |
|---|---|---|---|---|---|---|---|
| Store | | Accounts | | Category | | Hours | |
| Control | Value | Control | Value | Control | Value | Control | Value |
| R | G | R | 4000 | R | 004 | R | >2 |
| R | G | R | 4000 | R | 005 | R | >2 |
| R | G | R | 4000 | R | 006 | R | >0 |

In a second scenario, the same desired restrictions apply as in the first scenario but the user instead creates the rules using wildcards. Thus, another way to accomplish the same goals is as follows:

SCENARIO #2 TABLE

| | | | | Product | | | |
|---|---|---|---|---|---|---|---|
| Store | | Accounts | | Category | | Hours | |
| Control | Value | Control | Value | Control | Value | Control | Value |
| R | G | R | 4000 | R | 004:005 | R | >2 |
| R | G | R | 4000 | R | 006 | R | >0 |

In a third scenario, the same desired restrictions apply as in the first scenario but “not allowed” is utilized instead of required. Thus, yet another way to accomplish the same goals is as follows:

SCENARIO #3 TABLE

| | | | | Product | | | |
|---|---|---|---|---|---|---|---|
| Store | | Accounts | | Category | | Hours | |
| Control | Value | Control | Value | Control | Value | Control | Value |
| R | A:F | R | 4000 | R | 004:006 | NA | |

If the user enters an account and dimension combination of 4000 for Store G and Product Category of 006, the system will illustratively prompt the user for the Hours. Once the user has entered the quantity of hours, the system will illustratively pass or accept the combination. If the user enters an account dimension combination of 4000 for Store A and Product Category of 006, the system will fail the combination. If the user enters an account dimension combination of 4000 and Product Category of 005, the system will illustratively return G as the store value automatically because the validation rule has defined that store G is the only store that can use Product Category of 005 with account 4000. The system will then illustratively prompt the user for hours.

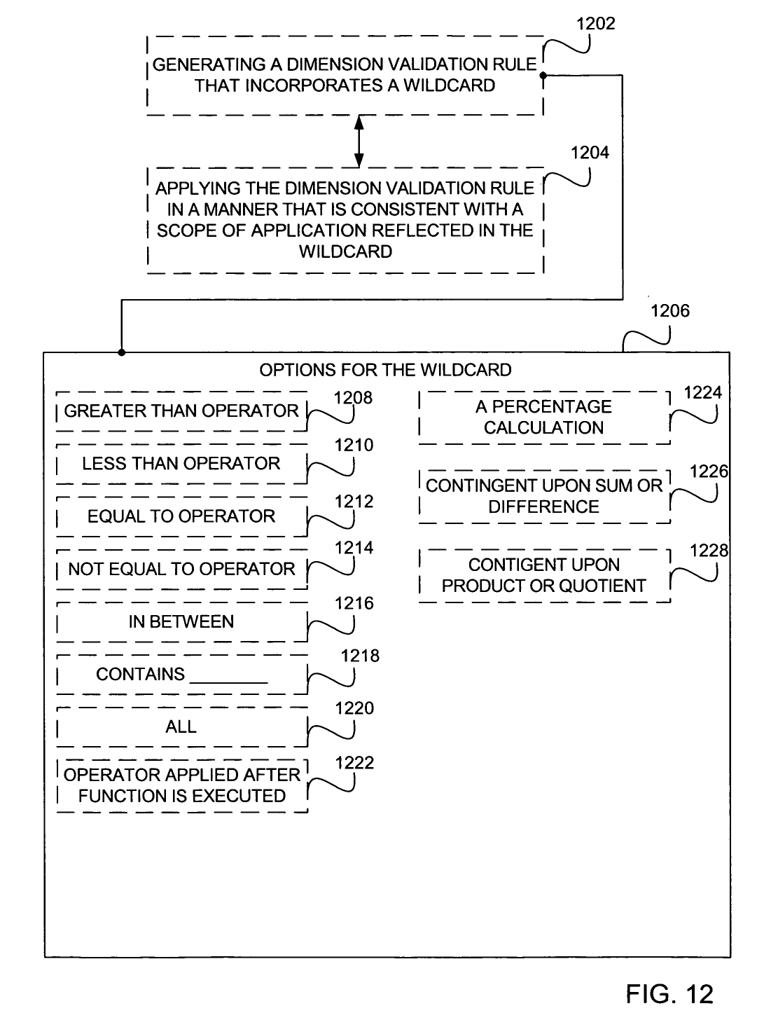

FIG. 12 is a block flow chart demonstrating steps associated with generating and applying a dimension validation rule. In accordance with block 1202, a dimension validation rule is generated and incorporates a wildcard. In accordance with block 1204, the dimension validation rule is applied in a manner that is consistent with a scope of application as reflected in the wildcard. Box 1206 shows options 1208-1228, which are options for limiting application of the rule.

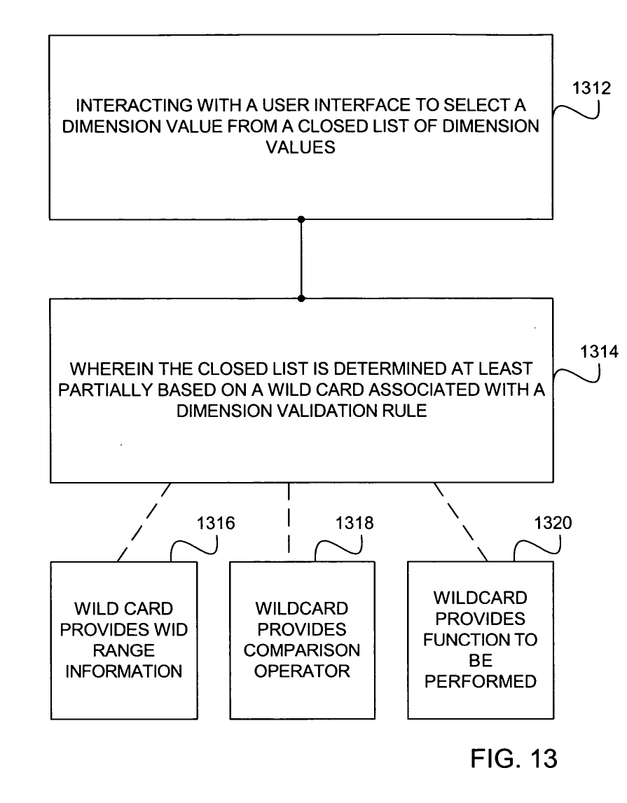

FIG. 13 is a block flow chart demonstrating steps associated with selecting a dimension value. In accordance with block 1312, a user interacts with an interface in order to select a dimension value from a closed list of dimension values. In accordance with block 1314, the closed list is determined, at least in part, based on a wild card associated with a dimension validation rule. Consistent with options 1206 illustrated in FIG. 12, boxes 1316, 1318 and 1320 are provided in FIG. 12 to demonstrate that wildcard limitations could be based on range information, a comparison operator (e.g., less than, greater than, equal to, not equal to, etc.), or comparison after a defined function is performed (e.g., adding multiple values, determining a percentage, etc.).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of configuring a computer-implemented accounting system, the method comprising generating a dimension validation rule that incorporates a wildcard.

2. The method of claim 2, further comprising applying the dimension validation rule in a manner that is consistent with a scope of application reflected in the wildcard.

3. The method of claim 1, wherein generating a dimension validation rule comprises generating a dimension validation rule that incorporates a wildcard with a ‘greater than’ operator.

4. The method of claim 1, wherein generating a dimension validation rule comprises generating a dimension validation rule that incorporates a wildcard with a ‘less than’ operator.

5. The method of claim 1, wherein generating a dimension validation rule comprises generating a dimension validation rule that incorporates a wildcard with an ‘equal to’ operator.

6. The method of claim 1, wherein generating a dimension validation rule comprises generating a dimension validation rule that incorporates a wildcard with a ‘not equal to’ operator.

7. The method of claim 1, wherein generating a dimension validation rule comprises generating a dimension validation rule that incorporates a wildcard that specifies a range.

8. The method of claim 1, wherein generating a dimension validation rule comprises generating a dimension validation rule that incorporates a wildcard that specifies an item of content that should be included.

9. The method of claim 1, wherein generating a dimension validation rule comprises generating a dimension validation rule that incorporates a wildcard with an ‘all’ operator indicating a comprehensive scheme of application.

10. The method of claim 1, wherein generating a dimension validation rule comprises generating a dimension validation rule that incorporates a wildcard that requires an operator to be applied after a function has been executed.

11. The method of claim 1, wherein generating a dimension validation rule comprises generating a dimension validation rule that incorporates a wildcard with a percentage based operator.

12. The method of claim 1, wherein generating a dimension validation rule comprises generating a dimension validation rule that incorporates a wildcard that involves a sum or difference to be determined.

13. The method of claim 1, wherein generating a dimension validation rule comprises generating a dimension validation rule that incorporates a wildcard that involves a product or quotient to be determined.

14. A method of entering transaction data into a computer-implemented accounting system, the method comprising interacting with a user interface to select a dimension value from a closed list of dimension values, wherein the closed list of dimension values is determined at least partially based upon a wildcard associated with a dimension validation rule.

15. The method of claim 14, wherein the wildcard provides information related to a range to be applied in order to determine what to include in the closed list.

16. The method of claim 14, wherein the wildcard provides at least one operator pertaining to a comparison to be performed in order to determine what to include in the closed list.

17. The method of claim 14, wherein the wildcard provides a function to be performed in order to determine what to include in the closed list.

18. A wildcard incorporated into a dimension validation rule, the wildcard being configured to limit application of a dimension validation rule.

19. The wildcard of claim 18, wherein the wildcard incorporates a function to be performed.

20. The wildcard of claim 18, wherein the wildcard incorporates range information.
